(19) United States
(12) Patent Application Publication
(10) Pub. No.: US 2013/0221191 A1
(43) Pub. Date: Aug. 29, 2013

(54) MOLD CORE PACKAGE FOR FORMING A POWDER SLUSH MOLDING TOOL

(71) Applicants: Harold P. Sears, Livonia, MI (US); James Todd Kloeb, Harrison Township, MI (US); Neal Floyd Enke, Tecumseh, MI (US); Alan Lawrence Jacobson, Ann Arbor, MI (US)

(72) Inventors: Harold P. Sears, Livonia, MI (US); James Todd Kloeb, Harrison Township, MI (US); Neal Floyd Enke, Tecumseh, MI (US); Alan Lawrence Jacobson, Ann Arbor, MI (US)

(73) Assignee: Ford Motor Company, Dearborn, MI (US)

(21) Appl. No.: 13/407,911

(22) Filed: Feb. 29, 2012

(51) Int. Cl. B28B 7/34

(52) U.S. Cl. 249/114.1; 427/133

(57) ABSTRACT

A powder slush molding tool having heating and cooling features cast as part of the tool, wherein the tool created using molds formed by additive manufacturing techniques, and wherein the tool is further used for making a flexible polymeric soft skin for use in a vehicle interior.

### CROSS-REFERENCE TO RELATED APPLICATIONS

This application is related to the following applications: U.S. patent application Ser. No. ______, filed on Feb. 29, 2012, entitled “MOLD CORE FOR FORMING A MOLDING TOOL” (Atty. Docket No. 83203377); U.S. patent application Ser. No. ______, filed on Feb. 29, 2012, entitled “MOLDING ASSEMBLY WITH HEATING AND COOLING SYSTEM” (Atty. Docket No. 83203379); U.S. patent application Ser. No. ______, filed on Feb. 29, 2012, entitled “INTERCHANGEABLE MOLD INSERTS” (Atty. Docket No. 83203382); U.S. patent application Ser. No. ______, entitled “MOLDING TOOL WITH CONFORMAL PORTIONS AND METHOD OF MAKING THE SAME” (Atty. Docket No. 83225806); and U.S. patent application Ser. No. ______, filed on Feb. 29, 2012, entitled “ADDITIVE FABRICATION TECHNOLOGIES FOR CREATING MOLDS FOR DIE COMPONENTS” (Atty. Docket No. 83225814), the entire disclosures of which are hereby incorporated herein by reference.

### FIELD OF THE INVENTION

The present invention generally relates to a powder slush molding tool or rotational molding tool having heating and cooling features cast as part of the tool, wherein the tool is used for making a flexible polymeric soft skin for use in a vehicle interior.

### BACKGROUND OF THE INVENTION

Powder slush molding tools, or rotational molding tools, are used in the creation of soft skins for vehicle parts, such as instrument panels, interior door panels, dashboards, armrests, and other vehicle parts that require a soft surface feel. Generally, the soft skins are created using the powder slush molding tool in an electro-formed nickel process or a nickel vapor deposition process. These processes require a powder slush molding tool having external cooling and heating features that are expensive and time consuming to impart on the powder slush molding tool. The present invention relates to a powder slush molding tool that is used in the process of making a soft skin wherein molds for creating the powder slush molding tool are formed using a three-dimensional printing process where heating and cooling features can be formed into the mold core packages, such that the heating and cooling features are translated into the cast powder slush molding tool for use in creating a soft skin.

### SUMMARY OF THE INVENTION

According to one aspect of the present invention, a method of making a polymeric skin for a vehicle interior includes the steps of (a) depositing a thin layer of particulate and (b) selectively applying a binder to the thin layer of particulate to define a cross-section of a mold core package. Steps (a) and (b) are repeated to produce a completed mold core package having a mold cavity disposed therein. A molten material is cast or otherwise applied to the mold cavity to form a cast powder slush molding tool. The cast molding tool is then coated with a polymeric material during a slush molding process to form the polymeric skin.

According to another aspect of the present invention, a method of making a mold core package for forming a powder slush molding tool includes the steps of (a) depositing a thin layer of particulate and (b) selectively applying a binder to the thin layer to define a cross-section of a mold core package. Steps (a) and (b) are repeated to produce a completed mold core package having a mold cavity disposed therein. A molten nickel-iron alloy having a coefficient of thermal expansion less than 5.0×10⁻⁶ in/in/° F. is cast or otherwise applied to the mold core package to form the cast powder slush molding tool.

According to yet another aspect of the present invention, a mold core package for forming a powder slush molding tool comprises a cope or upper mold box having a first molding surface defined by a plurality of stacked particulate layers. The mold core package further comprises a drag having a second molding surface defined by a plurality of stacked particulate layers. A casting cavity is defined by the first and second molding surfaces of the cope and drag respectively wherein the casting cavity has a negative configuration of a thermal control feature to be cast into the powder slush molding tool for use in a slush molding process.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a job box or rigid containment box prior to formation of a mold core package by a three-dimensional (3D) printing device;

FIG. 2 is a top perspective view of the job box of FIG. 1 as a layer of fine particulates is being spread in the job box;

FIG. 3 is a top perspective view of the job box of FIG. 1 as a binder is being added in the printing area by a 3D printing device;

FIG. 4 is a top perspective view of the job box of FIG. 1 after several layers of fine particulates have been printed by a 3D printing device;

FIG. 5 is a top perspective view of the job box of FIG. 1 with a fresh layer of fine particulates being spread over the print surface of the job box;

FIG. 6 is a top perspective view of the job box of FIG. 1 after a full mold core package has been printed and the job box removed from the printing device;

FIG. 6A is a perspective view of a mold core package as removed from the job box, wherein the mold core package is made from bound particulate and excess unbound particulate is being removed;

FIG. 7 is a top perspective view of a cope mold as shown in FIG. 6A;

FIG. 8 is a top perspective view of a drag mold disposed in a casting box;

FIG. 9 is a top perspective cross-sectional view of a mold core package positioned for casting a molten material into a mold cavity defined by the union of the cope and drag molds;

FIG. 10 is a top perspective view of the resulting powder slush mold tool or shell as cast from the mold core package;

FIG. 10A is a bottom perspective view of the powder slush molding tool of FIG. 10;

FIG. 10B is a top perspective view of a powder slush molding tool having a grain pattern etched on an A-side of the molding tool;

FIG. 11 is a top perspective view of a cope mold having a molding surface with external heating and cooling features configured thereon;

FIG. 11A is a bottom perspective view of a powder slush molding tool as cast using the cope mold of FIG. 11, such that the powder slush molding tool has external heating and cooling features on a B-side of the powder slush molding tool;

FIG. 12 is a top perspective cross-sectional view of a sand mold package comprised of the cope and drag molds of FIGS. 7-8 positioned with a displacement core disposed there between;

FIG. 12A is a cross-sectional view of another embodiment of a powder slush molding tool having a conformal heating and cooling reservoir extending through a portion of the powder slush molding tool;

FIG. 13 is a cross-sectional view of another embodiment of a powder slush molding tool having a conformal line extending through a portion of the molding tool;

FIG. 14 is a flow chart representing the use of a powder slush molding tool in a slush molding process to make a polymeric soft skin;

FIG. 15 is a fragmentary perspective view of a door panel having a soft skin disposed thereon; and

FIG. 15A is a fragmentary perspective view of the soft skin of FIG. 15, taken at location XVA, having a grain pattern disposed thereon.

### DETAILED DESCRIPTION OF THE EMBODIMENTS

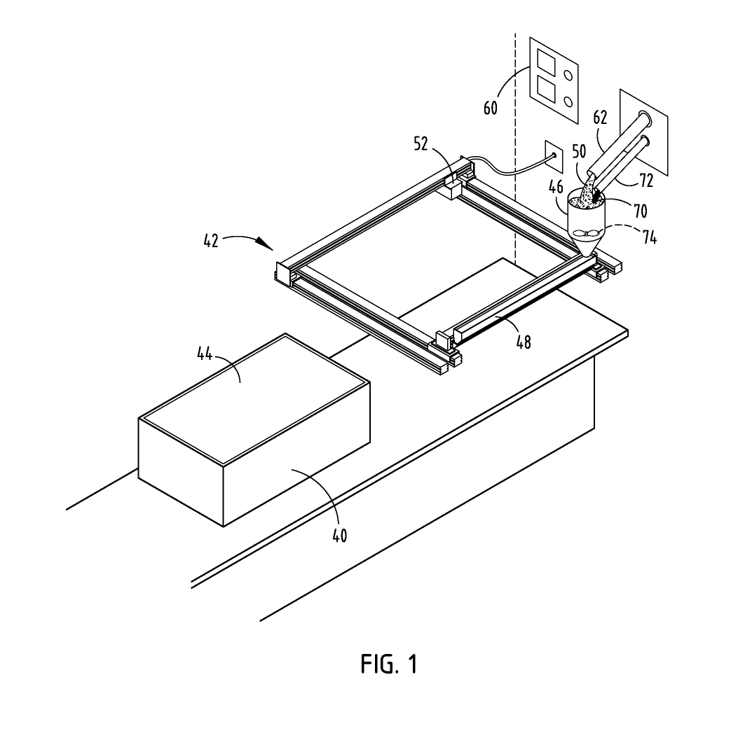

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

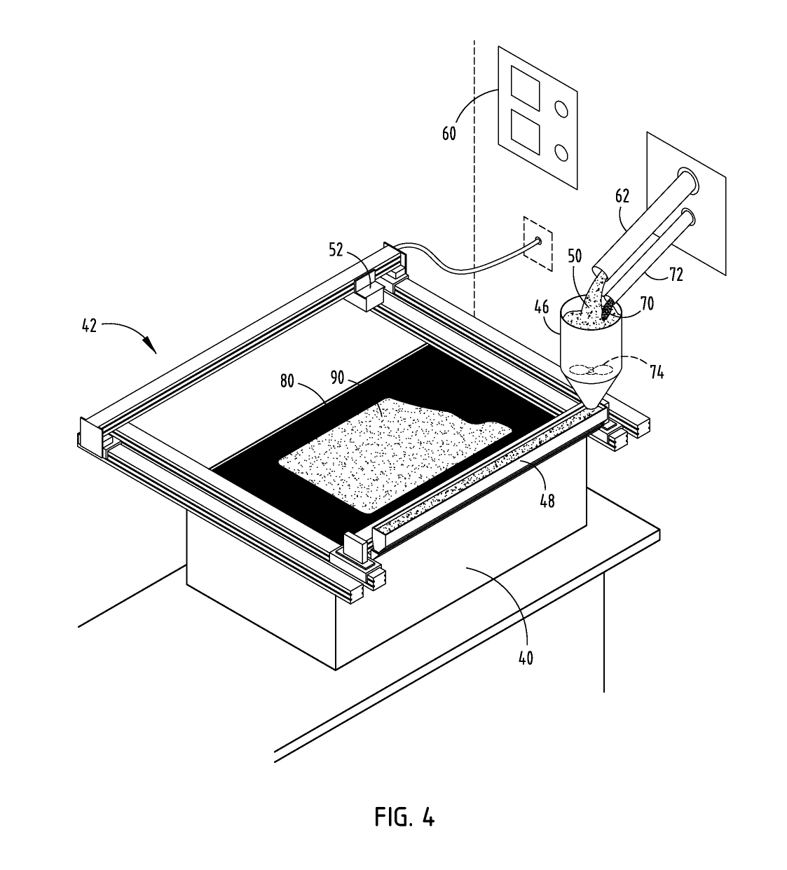

Referring now to FIGS. 1-6, an additive manufacturing technique is described and exemplified by a sandprinting process. However, it is to be understood that other like additive manufacturing techniques can be used in accordance with the present invention. As shown in FIGS. 1-6, a job box 40 formed from any of a number of materials including wood, metal, etc., is positioned below a printing device 42. The job box 40 defines a print area 44 within which a mold core package and components thereof, will be constructed from a plurality of stacked particulate layers as further described below. The printing device 42 is capable of printing three-dimensional (3D) molds, cores, and mold core packages. For purposes of the description of the formation of the mold core package components using the printing process discussed below, a cope mold 100, as shown in FIGS. 6A, 7, and 9, will be referenced, although it is to be understood that a drag mold 110 of FIG. 8 is also formed using a similar process, or is simultaneously formed with cope mold 100 in a single printing process.

The printing device 42 includes a hopper 46 and a deposition trough 48, which lays a thin layer of activated fine particulates 50, such as silica sand, ceramic-sand mixes, etc., inside the print area 44. The particulates 50 may be of any size, including 0.002 mm to 2 mm in diameter. The printing device 42 also includes a binder deposition device or a binder dispenser 52. As disclosed in detail below, the binder dispenser 52 sprays a thin layer of a binder or binding agent 16 in the shape of a single layer of the desired mold 100. Repetition of the layering of sand and spraying of binding agent 16 by the binder dispenser 52 on the fine particulates 50 results in the production of a three-dimensional mold core package so-formed from a plurality of stacked particulate layers 14, as shown in FIG. 9. The 3D mold 100 is manufactured additively over a length of time sufficient to print each thin layer 14 (FIG. 9), which measures approximately 0.28 mm, of the fine particulates 50 in succession to form a completed mold 100. The mold 100 will ultimately be used as a sacrificial mold to fabricate a powder slush molding tool or rotational molding tool 130, as shown in FIG. 10.

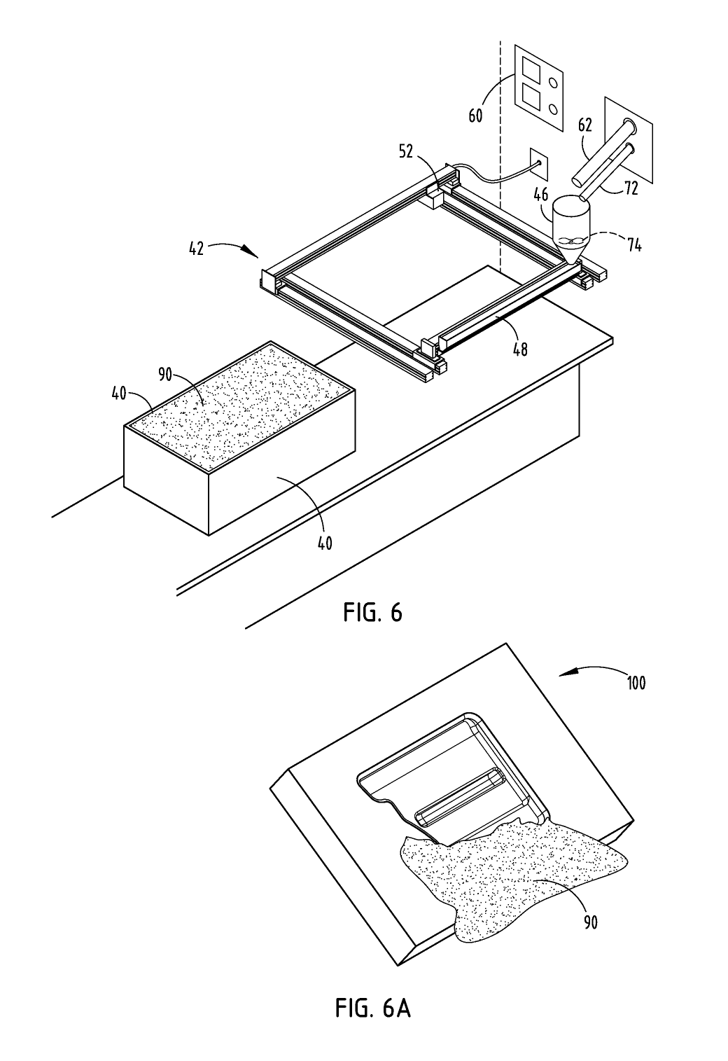

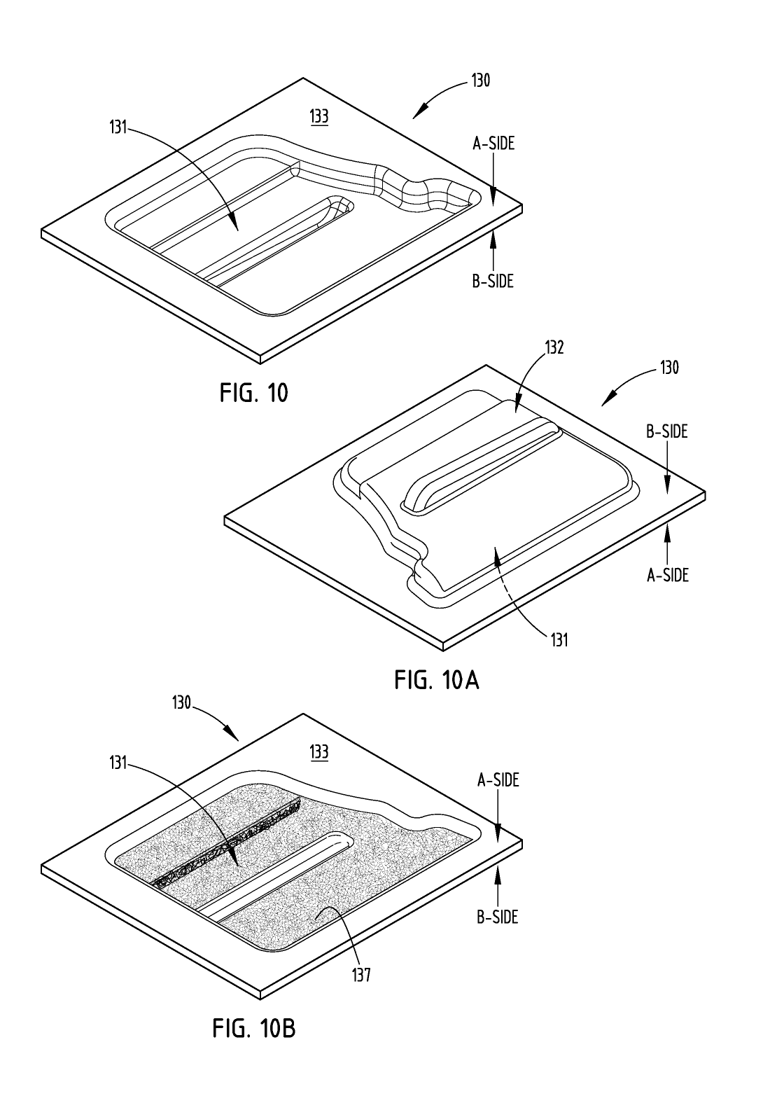

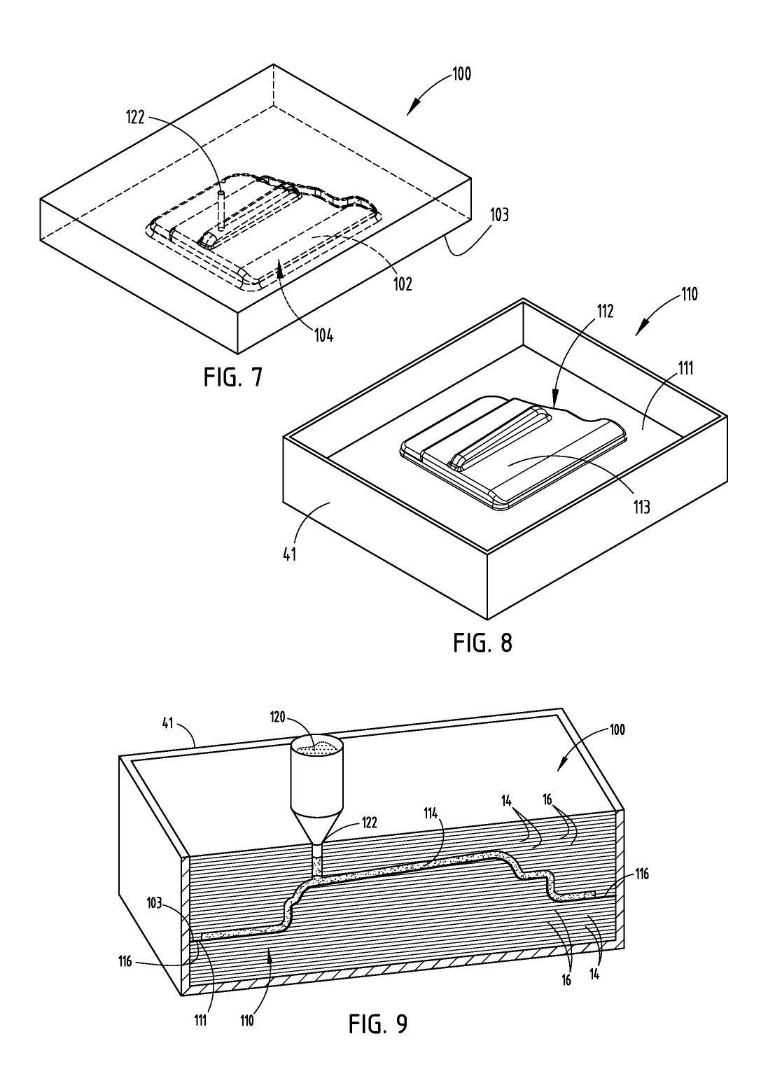

With specific reference to FIG. 1, a computer-aided design (CAD) program is developed wherein the specific configurations of the mold 100 (FIG. 7) are entered and loaded up on a computer 60, which is coupled to the printing device 42. The computer 60 feeds the information from the CAD program with the specific configurations of the mold core package 100 to the printing device 42 for formation of the mold 100.

It is contemplated that CAD, or any other form of 3D modeling software, can be used to provide sufficient information for the 3D printing device 42 to form the desired mold 100. Prior to activation of the 3D printing device 42, a predetermined quantity of the fine particulates 50 is dumped into the hopper 46 by a particulate spout 62, along with an activation coating or activator 70 supplied by an activator spout 72. Although the illustrated embodiment uses a fine sand as the fine particulate 50, as noted above, the fine particulate 50 may include any of a variety of materials or combinations thereof suitable for the additive manufacturing techniques disclosed herein. The fine particulates 50 are mixed in the hopper 46 with the activator 70. The mixture of fine particulates 50 and activator 70 may be mixed by an agitator 74 or other known mixing device such that the fine particulates 50 become thoroughly mixed and activated. After the fine particulates 50 and activator 70 have been thoroughly mixed, the fine particulates 50 are moved to the deposition trough 48.

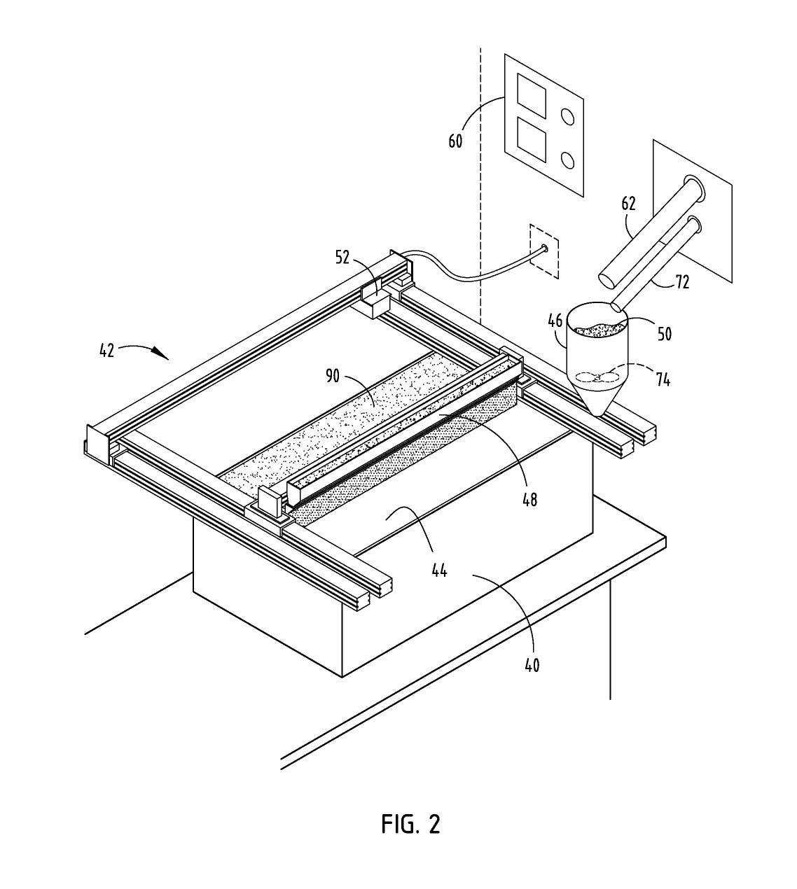

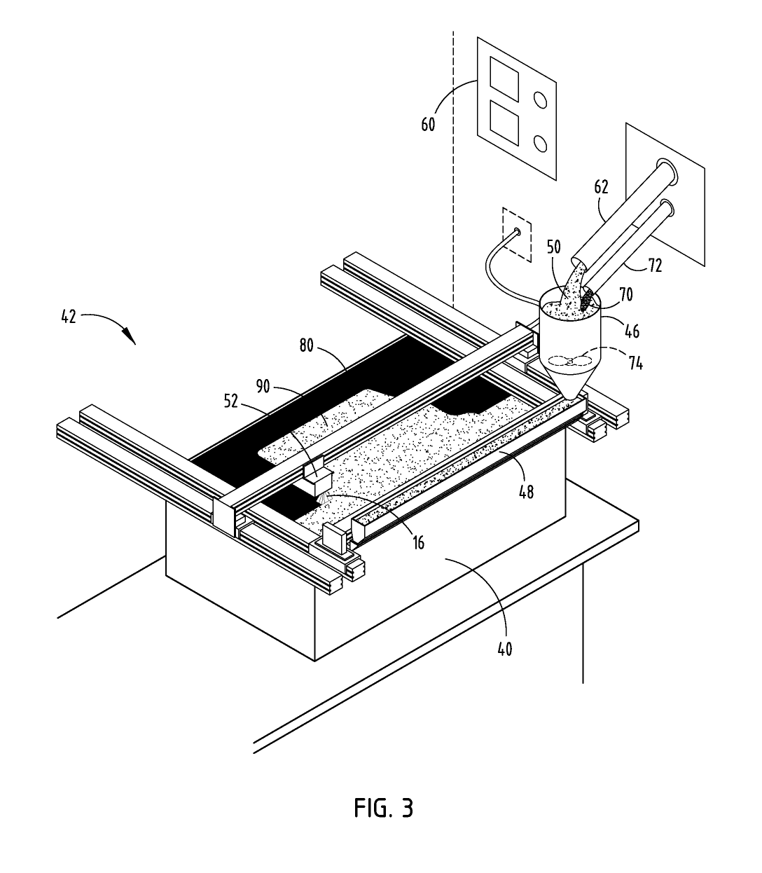

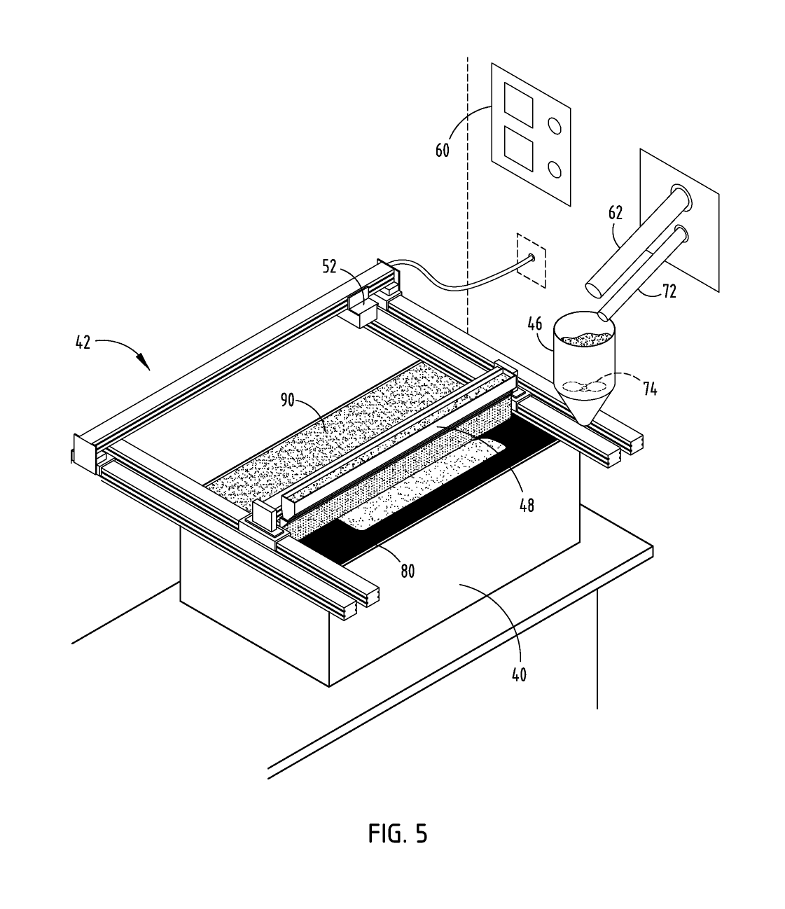

Referring now to FIGS. 2-6, after the activated fine particulates 50 have been moved to the deposition trough 48, the activated fine particulates 50 are spread across the print area 44 in a thin even layer of unbound activated fine particulates or unbound sand 90 by the deposition trough 48. After being spread in a thin layer on the print area 44 in the job box 40, the activated fine particulates 50 are sprayed with the binding agent 16 (FIG. 3). The binding agent 16 is dispensed from the binder dispenser 52, which sprays a thin layer of the binding agent 16 in a pattern 80 that represents a first thin cross-sectional layer 14 (FIG. 9) of the desired mold 100. After the binding agent 16 has been sprayed, another mixture of fine particulates 50 and activator 70 is prepared and dumped into the deposition trough 48. The deposition trough 48 then dispenses another layer 90 of unbound activated fine particulates 50 over the previously spread fine particulates 50 layer in the job box 40, as shown in FIG. 5. The binder dispenser 52 passes over the print area 44 again, spraying a thin layer of the binding agent 16 in the pattern 80 that represents a second thin cross-sectional layer of the desired mold 100 adjacent to the first thin cross-sectional layer. These steps are repeated many times until every thin cross-sectional layer of the completed mold 100 has been printed (FIG. 6). Using this additive manufacturing technique, virtually any shape of a mold core package can be formed. Further, a mold core package produced using an additive manufacturing process, such as 3D sandprinting can have internal structural features that cannot otherwise be created by other known subtractive methods.

As shown in FIG. 7, a completed upper mold, or cope, 100 has been formed using the additive manufacturing process described above, such that a contoured surface 102 is formed in a depression 104 wherein the contoured surface or molding surface 102 comprises the contours of the desired powder slush molding tool or shell 130 (FIG. 10) to be produced in a subsequent casting process described below. The contoured surface 102 and depression 104 will have a configuration of a vehicle interior structure for which a soft skin is desired as a cover.

As shown in FIG. 8, a lower mold, or drag, 110 is shown as printed using the additive 3D printing process described above. The lower mold 110 has a contoured protrusion 112 that is generally reciprocal in configuration to the contoured surface 102 of upper mold 100, such that, as shown in FIG. 9, when the upper mold 100 and the lower mold 110 are stacked upon each other in a casting box 41, a void or mold cavity 114 is formed having the desired contours of the powder slush molding tool to be cast. The union of the upper mold (cope) 100 and the lower mold (drag) 110 forms a mold core package, which in this case is a sand mold package. The casting box 41 can be used for support if necessary, but it is to be understood that the mold core package can also be used in a casting process without any additional support.

As shown in FIG. 7, the upper mold, or cope, 100 has a flat surface 103 surrounding the depression 104, which has a contoured surface 102 for molding a B-side of a powder slush molding tool 130 (FIG. 10A). As shown in FIG. 8, the lower mold, or drag, 110 comprises a protrusion 112 with a contoured surface 113 for molding an A-side of a powder slush molding tool 130 (FIG. 10). The lower mold 110 further comprises a flat surface 111 which surrounds the protrusion 112 of the lower mold 110.

As shown in FIG. 9, the upper mold 100 and lower mold 110 are positioned adjacent one another to form a sand mold package for casting a molten material 120 into a molten material access point 122 disposed on the upper mold 100. The upper mold 100 and lower mold 110 connect at their respective flat surfaces 103, 111 at a parting line 116. The flat surfaces 103 and 111 of the upper mold 100 and lower mold 110 can also be referred to as parting planes. During the casting process, the molten material 120 is cast into the mold cavity 114 defined by the void created by the first mold surface 102 of the cope 100, and the second mold surface 113 of the drag 110. It is further contemplated that the access point 122 can extend through the cope 100 into the drag 110 such that molten material 120 fills the mold cavity 114 from the bottom up. Once the molten material 120 is cast into the sand mold package, it is allowed to cool to form a powder slush molding tool or shell 130 as shown in FIG. 10. When the molten material 120 has cooled, the molds 100, 110 are then broken away or otherwise destroyed to release the shell 130, such that the molds 100, 110 are sacrificial in nature. As cast, the shell 130 comprises a near net-shape of the mold cavity 114 (FIG. 9) and further comprises an A-side and a B-side. A depression 131 is disposed on the A-side of the shell 130 and a protrusion 132 is disposed on the B-side of the shell 130 (FIG. 10A). Disposed about the depression 131 and the protrusion 132 on both the A-side and the B-side of the shell 130 is a flat surface 133.

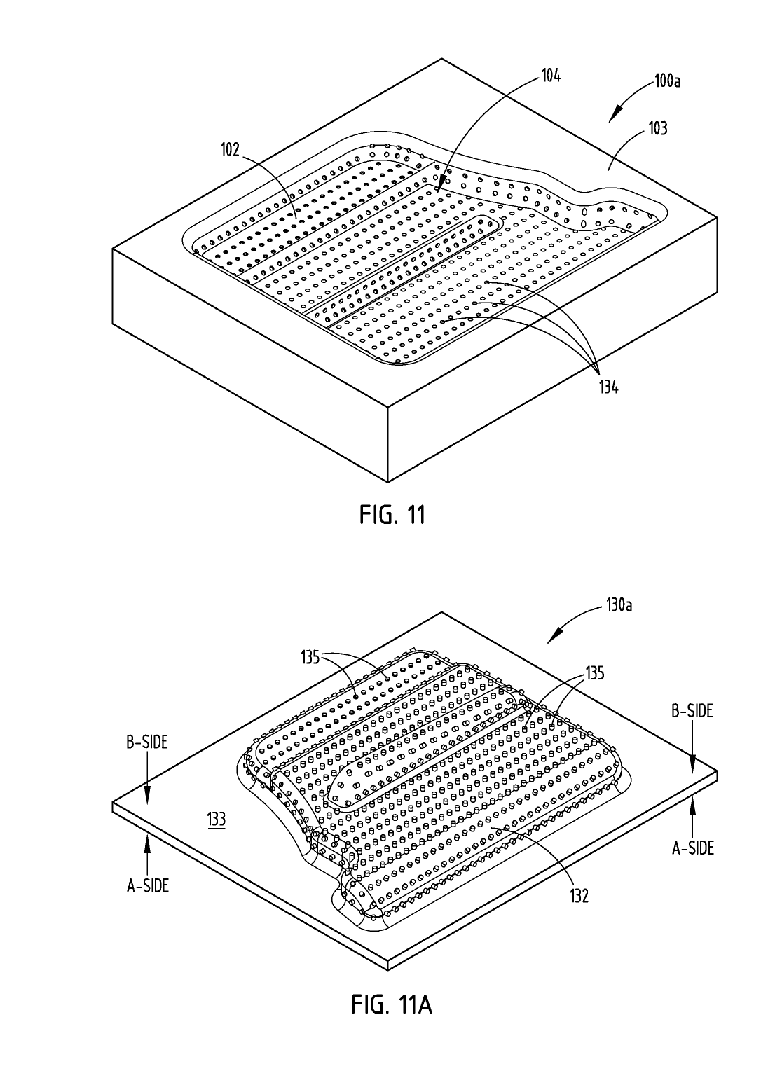

Referring now to FIGS. 11 and 11A, another embodiment of an upper mold 100a is shown in a similar configuration as the upper mold depicted in FIG. 7. The mold 100a of FIG. 11 differs from the mold 100 as shown in FIG. 7 in that it has a negative configuration of a thermal control feature in the form of a plurality of cavities or recesses 134 disposed on the mold surface 102 which are used to impart an external thermal control feature in the form of heat sinks, fins, or pins 135 (FIG. 11A) on a B-side of the shell 130a. The pins 135 are cast as the shell 130a is cast, and the pins 135 function as a temperature controlling mechanism, or thermal control feature, for heating or cooling the shell 130a using heated or cooled airflow in a slush molding process to form a flexible polymeric skin. The slush molding process is further described below.

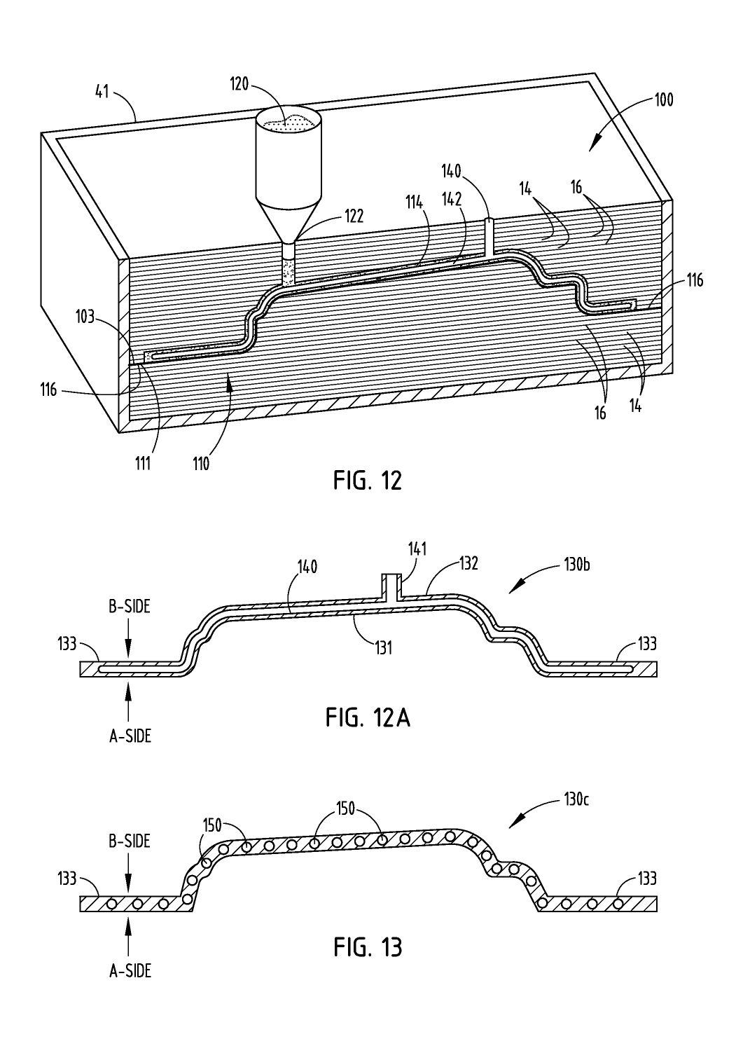

As shown in FIGS. 12 and 12A, another embodiment of a shell 130b can be cast having a fluid cavity in the form of a conformal reservoir 140 disposed between the A-side and B-side of the shell 130b. To create the conformal reservoir 140, a displacement core 142 is printed using the additive manufacturing process noted above and placed with supports into the mold cavity 114, as shown in FIG. 12 to form a negative configuration of a thermal control feature in the mold cavity 114. In this way, the displacement core 142 displaces the molten material 120, such that, as the cast molten material 120 cools, a shell 130b will be formed having an internally disposed thermal control feature in the form of a conformal reservoir 140. In the embodiment shown in FIG. 12A, the conformal reservoir 140 evenly follows the contours of the A-side and B-side of the shell 130b, respectively. However, it is contemplated that the displacement core 142 can have a variety of geometric configurations and passageways printed thereon that can alter the heating or cooling properties of the cast shell 130b by controlling the exposure of portions of either the A-side or B-side of the shell 130b to a thermal fluid that is pumped into the reservoir 140 when the shell 130b is used in a slush molding process that can both heat or cool the shell 130b.

During the casting process, the molten material 120 cools to form the shell 130b and the printed displacement core 142 and any associated supports are structurally destroyed, such that resulting loose or unbound sand can then be washed out or otherwise removed. The shell 130b further comprises at least one access port 141 through which the thermal fluid, heating or cooling fluid, can be pumped into and out of the conformal reservoir 140. In this way, the shell 130 can be rapidly heated or cooled internally using a heating or cooling fluid as pumped into the conformal reservoir 140, such that, heating and cooling of the mold 130b is precisely controlled in the creation of a polymeric skin using a slush molding process, as further described below.

Another thermal control feature contemplated by the present invention is the incorporation of conformal lines or tubes 150 as disposed between the A-side and B-side of another embodiment of a shell 130c, as shown in FIG. 13. Similar to the use of a heating or cooling fluid in the shell embodiment 130b, thermal fluid can be pumped into the conformal lines 150 to heat or cool the shell 130c during a slush molding process. As noted above, the displacement core 142 can have a variety of configurations as it is formed using an additive manufacturing process. Thus, for creation of the shell 130c of FIG. 13, a displacement core would be placed in the molding cavity having a negative configuration of the desired conformal lines 150 of the shell 130c, shown in FIG. 13. It is contemplated that such a displacement core could be in the form of a continuous serpentine configuration of sacrificial printed lines created by a sandprinting process which are disposed and supported in a float-like manner in the mold cavity that would create the conformal lines 150, as shown in the shell 130c of FIG. 13, such that a thermal fluid could be pumped into and travel within the conformal lines 150 to heat or cool the shell 130c as needed.

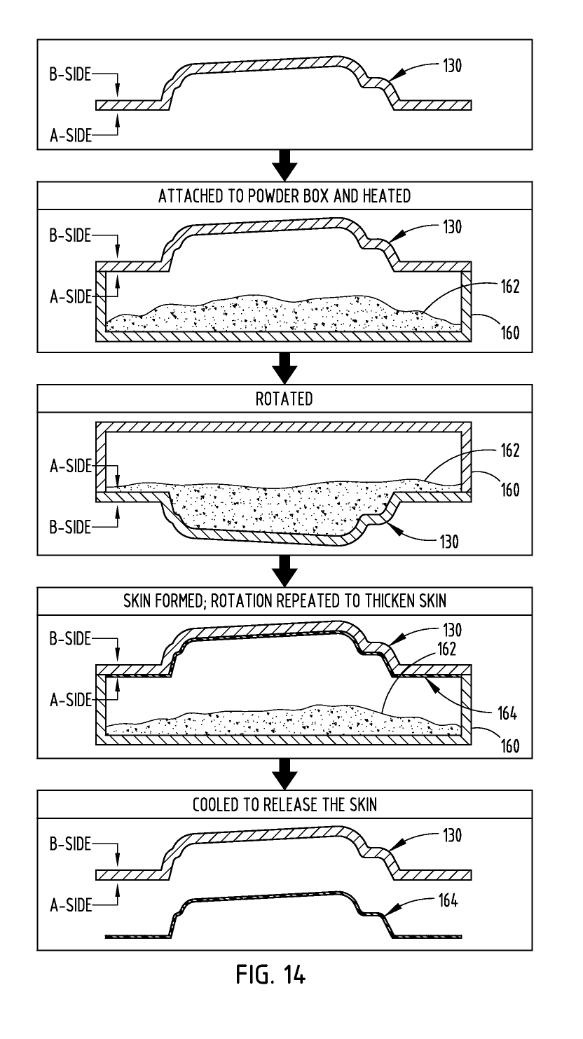

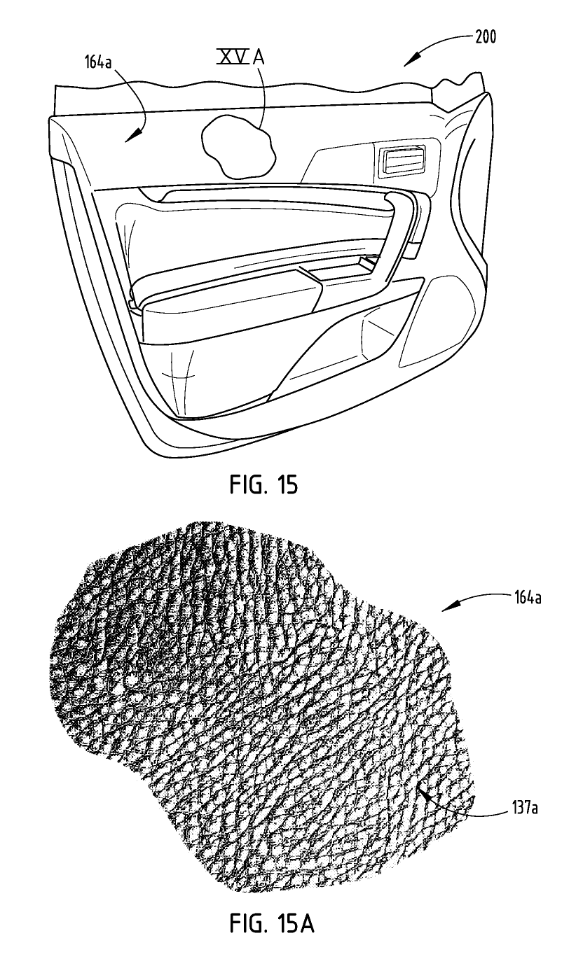

As shown in FIG. 10B, the shell 130 can have a grain pattern 137 disposed anywhere on the A-side of the shell 130. The grain pattern 137 can be created by any suitable etching process, such as acid etching, laser etching, or mechanical etching, to provide a grain pattern having a grain depth of anywhere from 5 to 1000 microns. The grain pattern 137 is used in the slush molding process to create a flexible polymeric skin having the inverse of the grain pattern 137 as etched into the A-side of the shell 130 to provide a textured, flexible polymeric skin as described below with reference to FIGS. 14-15A.

The formation of the powder slush molding tool or shell of the present invention offers several advantages over the electro-formed nickel and nickel vapor deposition processes currently in use. Both of these known processes require the use of a target model which is generally a full numerical control (NC) cut model that has been wrapped with a grained vinyl. Using the electro-formed nickel process, it can take in excess of 20 weeks to make a fully grained nickel shell tool. The nickel shell tool of the known processes must have cooling and heating features externally added after its formation. For a nickel shell tool using air as a thermal control medium, hundreds of small pins must be soldered onto the B-side exterior of the tool. If the nickel shell tool is an oil tool, then several steel oil lines are soldered onto the B-side exterior of the tool. With either process, multiple metallic materials having varying coefficients of thermal expansion must be introduced onto the tool. This leads to the accumulation of thermal stresses during cycling of the tool and ultimately the failure of the tool after approximately 40,000 shots due to cracks and other failures caused by thermal fatigue.

The cast shell of the present invention uses an alloy having a very low coefficient of thermal expansion that is uniform throughout the shell and any associated heating and cooling features. Such an alloy is described in U.S. Provisional Patent Application No. 61/268,369, entitled “Method of Producing a Cast Skin or Slush Mold,” and PCT International Publication No. WO 2010/144786, entitled “Low CTE Slush Molds with Textured Surface, and Method of Making and Using the Same,” which are incorporated herein in their entirety. Using the three-dimensional CAD model of the present invention, a three-dimensional mold core package can be printed in sand having added machine stock on the A-side of the shell and heat sink features disposed on the B-side of the shell, or conformable oil passages in the form of bladders, reservoirs, or lines can be produced by sandprinting displacement cores which form passages disposed between the A-side and B-side of the shell. Thus, the printing process allows for any number of complete configurations to be printed in a mold core package, and then translated to a tool by casting the tool using the geometrically complex mold core package. The three-dimensional printing process prints 0.28 mm thick layers of the mold at a time, such that the complex geometric configurations and thermal controlling features can be formed in the mold, where such geometrical configurations are often difficult or impractical to produce using standard machining processes.

As shown in FIG. 9, the molten material or alloy 120 is melted and poured into the mold cavity 114 of the joined sand molds 100, 110 making up the sand core package where it solidifies and cools to form the desired shell 130 (FIG. 10). Once the molten material 120 has solidified, the upper and lower sand molds 100, 110 are broken away, leaving behind a near net-shaped shell 130 having the desired heating and cooling features, such as those shown in FIGS. 11A, 12A and 13. It is contemplated that approximately 5 mm of machine stock is disposed on the A-side of the shell 130 which can then be machined or milled to provide a finished A-side as needed. As noted above, the A-side can then be etched to have a desired textured pattern which is later imparted on a polymeric skin during the powder slush molding process. Given the accuracy and precision of the 3D printing of the mold core packages, the cast shell 130 has a near net-shape of the finished part, such that only approximately 5 mm of machine stock is needed to produce a part that can be finished or finished with a grain pattern. The near net-shape of the shell 130 results in less stock material, molten material 120, used in the overall casting process.

Having been fully cast with an alloy having little or virtually no thermal expansion characteristics within the operating temperature range of the shell 130 (generally 100° to 500° F.), accumulated thermal stresses in the shell 130 of the present invention are significantly reduced since the heating and cooling features are not added on after casting using a different metallic material. Thus, the shell 130 of the present invention has a considerably longer life span due to the lack of thermal stresses which lead to thermal fatigue and ultimately failure of the tool in other processes. It is contemplated that a nickel-iron alloy having a coefficient of thermal expansion of less than 5.0×10⁻⁶ in./in./F° can be used in the casting of the shell 130. Further, this nickel-iron alloy has increased thermal conductivity, such that it can be rapidly heated or cooled using the described heating and cooling features. This reduces cycle times when the shell 130 is used in a slush molding process and gives the operator greater control during the molding process.

As noted above, the A-side of the shell can be etched with a grain pattern and can also have areas where the finished machine surface is not etched. In this way, the A-side of the shell can have a variety of textures to impart on a polymeric skin, such as a grained pattern 137, FIG. 10B, or glossy finish.

As shown in FIG. 14, a flow diagram demonstrates the slush molding process used with the mold tool or shell of the present invention to create a polymeric skin. As depicted in FIG. 14, a shell 130 having an A-side and a B-side is attached to a powder box 160 containing a powder 162 comprised of polymeric particulate. The cast shell 130 is then heated using either air or fluid, such as oil, using one or more of the heating and cooling features (not shown) described above. In an air heating process, an air shell will be used having an external thermal control feature, such as that shown in FIG. 11A. In an oil or fluid process, an oil or fluid shell will be used having an internal heating and cooling feature in the form of a conformal reservoir, as shown in FIGS. 12A and 13. Once the shell 130 is attached to a powder box 160 and heated, the slush mold apparatus is rotated, such that the powder 162 containing polymeric particles contacts the heated A-side of the shell 130. The heat from the shell 130 causes the polymeric particles of the powder 162 to melt and adhere to the A-side of the shell 130. The apparatus can be rotated any number of times to create a desired thickness of a polymeric skin 164. The shell 130 is then cooled using the associated thermal control feature, and the skin 164 is removed. As noted above, the A-side of the shell 130 can have any number of etched grain or glossy patterns, such that the skin 164, when removed from the shell 130, will have the correlating pattern imparted by the A-side of the shell 130 disposed thereon. The flexible textured polymeric skin 164 can then be used to cover any number of vehicle parts in a vehicle interior, such as an instrument panel, a door panel (FIG. 15), armrest, console covers, and any other vehicle interior surface where such a textured flexible polymeric skin is desired.

Referring now to FIG. 15, a door panel 200 is shown having a soft skin 164a disposed thereon. It is noted that the soft skin 164a can cover part or all of the door panel 200 depending on the manufacturer's need. The soft skin 164a is created in a slush molding process similar to that shown in FIG. 14. As shown in FIG. 15A, a fragmentary view of the soft skin 164a has a grain pattern 137a, which indicates that the soft skin 164a was created in a slush molding process with a shell having a grain pattern disposed thereon, such as the shell 130 shown in FIG. 10B, having the grain pattern 137. Thus, the grain pattern 137 of the shell 130 embosses at least a portion of the polymeric skin 164a.

The mold core packages and methods of making tools from the mold core packages, such as, but not limited to molding tools, as disclosed herein provide an improved ability to cool all areas of a molding tool evenly thereby reducing the variance in the thickness of the soft skin and improving the overall quality of the soft skin. In addition, the accuracy associated with making the mold core packages from the printing process provides for better part quality, precision, and design flexibility. The conformal lines allow for improved thermal capabilities. Multiple lines for heating and cooling are eliminated in favor of integrated heating and cooling conformal lines that can be configured to match the desired thermal loading required to improve tool quality as well as tool and part quality. Further, the mold core packages and the tools made from the mold core packages can be designed to improve cycle time, thereby increasing part manufacturing capacity.

It will be understood by one having ordinary skill in the art that construction of the described invention and other components is not limited to any specific material. Other exemplary embodiments of the invention disclosed herein may be formed from a wide variety of materials and additive manufacturing techniques, unless described otherwise herein.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired embodiment and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A method of making a polymeric skin for a vehicle, comprising:
(a) depositing a thin layer of particulate;
(b) selectively applying a binder to the thin layer of particulate to define a cross-section of a mold core package;
repeating steps (a) and (b) to produce a mold core package having a mold cavity;
applying a molten material to the mold cavity to form a cast molding tool; and
coating the cast molding tool with a polymeric material during a slush molding process to form the polymeric skin.

2. The method of claim 1, further comprising:
inserting a displacement core within the mold cavity prior to applying the molten material to provide an internal conformal reservoir in the cast molding tool.

3. The method of claim 2, further comprising:
heating the cast molding tool by introducing a thermal fluid into the conformal reservoir before coating the cast molding tool with a polymeric material.

4. The method of claim 1, wherein the step of repeating steps (a) and (b) produces the mold cavity to include a plurality of recesses.

5. The method of claim 4, wherein the step of applying a molten material to the mold cavity to form a cast molding tool further comprises:
filing the plurality of recesses with the molten material to form an external thermal control feature disposed on a surface of the cast molding tool.

6. The method of claim 5, further comprising:
heating the cast molding tool having an external thermal control feature before coating the cast molding tool with a polymeric material by introducing an air flow to the external thermal control feature.

7. The method of claim 1, further comprising:
etching a grain pattern on a surface of the cast molding tool.

8. The method of claim 7, wherein the step of coating the cast molding tool with a polymeric material during a slush molding process to form the polymeric skin further comprises:
embossing the grain pattern on at least a portion of the polymeric skin.

9. A method of making a mold core package for forming a powder slush molding tool, comprising:
(a) depositing a thin layer of particulate;
(b) selectively applying a binder to the thin layer to define a cross-section of a mold core package;
repeating steps (a) and (b) to produce a mold core package having a mold cavity;
applying a molten nickel-iron alloy having a coefficient of thermal expansion less than 5.0×10⁻⁶ in./in./° F. to the mold core package to form the cast powder slush molding tool.

10. The method of claim 9, further comprising:
inserting a displacement core within the mold cavity prior to applying a molten material to provide an internal conformal reservoir in the cast powder slush molding tool.

11. The method of claim 10, further comprising:
heating the cast molding tool by introducing a thermal fluid into the conformal reservoir before coating the cast powder slush molding tool with a polymeric material.

12. The method of claim 9, wherein the step of repeating steps (a) and (b) produces the mold cavity to include a plurality of recesses.

13. The method of claim 12, wherein the step of applying a molten material to the mold cavity to form a cast molding tool further comprises:
filing the plurality of recesses with the molten material to form an external thermal control feature disposed on a surface of the cast molding tool.

14. The method of claim 13, further comprising:
heating the cast molding tool having an external thermal control feature before coating the cast molding tool with a polymeric material by introducing an air flow to the external thermal control feature.

15. The method of claim 9, further comprising:
etching a grain pattern on a surface of the cast molding tool.

16. A mold core package for forming a powder slush molding tool, comprising:
a cope having a first molding surface defined by a plurality of stacked particulate layers;
a drag having a second molding surface defined by a plurality of stacked particulate layers; and
a casting cavity defined by the first and second molding surfaces having a negative configuration of a thermal control feature to be cast into the powder slush molding tool for use in a slush molding process.

17. A mold core package as set forth in claim 16, wherein:
the cope and drag are printed sand mold packages formed using an additive manufacturing process.

18. A mold core package as set forth in claim 16, wherein:
the negative configuration of a thermal control feature comprises a displacement core disposed within the mold cavity, wherein the displacement core is adapted to displace a molten material applied to the mold core during a casting process to form the powder slush molding tool.

19. A mold core package as set forth in claim 16, wherein:
the negative configuration of a thermal control feature comprises a plurality of recesses disposed on one of the first molding surface and second molding surface.
